(19) United States
(12) Patent Application Publication
(10) Pub. No.: US 2008/0052410 A1
(43) Pub. Date: Feb. 28, 2008

(54) Method, System and Means for Transmitting a Data Package to a Plurality of Computers Distributed Through a Set of Distinct Local Networks

(76) Inventor: Serge Soulet, Rennes (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/666,719

(22) PCT Filed: Oct. 27, 2005
(86) PCT No.: PCT/FR05/50912

§ 371 Date: Sep. 4, 2007

(30) Foreign Application Priority Data
Oct. 29, 2004 (FR) 0411606

(51) Int. Cl. G06F 15/173

(52) U.S. Cl. 709/244

(57) ABSTRACT

A system and a method of distributing a data package (1) by a control server (3) to a plurality of computers (7a to 11c) distributed over a set of separate local networks (7, 9, 11). At the request of a particular computer (7a) of a particular local network (7) wishing to download the data package (1), the control server (3) communicates to said particular computer (7a) either the name of a computer belonging to the particular local network (7) that has previously downloaded said data package (1), called a depository computer for said data package, or the address of a central storage location (17) holding said data package (1) if the particular local network (7) does not include another computer that has previously downloaded said data package (1).

### TECHNICAL FIELD OF THE INVENTION

The invention relates to a control server distributing a data package to a plurality of computers distributed over a set of separate local networks, and in particular to deploying information systems of large businesses having a large installed base of computers distributed over many sites.

### BACKGROUND OF THE INVENTION

In the context of large information technology (IT) systems, all businesses are confronted with the necessity of distributing software quickly, either following virus attacks requiring urgent software updates or simply for upgrading or distributing voluminous software.

Similarly, in the Internet environment, businesses that distribute software, CDs, films, DVDs, or books in an electronic form via e-commerce sites are confronted with the same problem of distributing voluminous data.

Conventional distribution tools rely on relay machines.

FIG. 3 shows a central distribution server 103 connected via an information network 105 to a plurality of relay servers 141, 151, and 161. Furthermore, each of the relay servers 141, 151, and 161 is connected via a respective local information network 107, 109, and 111 to a respective plurality of computers 107a to 107c, 109a to 109c, and 111a to 111c.

This architecture means that it is possible to ensure that a data package is distributed only once to each of the computers 107a to 111c, avoiding congestion of the information network 105, but causing congestion of the networks 107 to 111.

However, an urgent voluminous mass distribution often conflicts with the capacity of the relay servers 141, 151, and 161 or with the availability of sufficient bandwidth on capillary networks.

Some isolated sites are connected to the information networks only at very low bit rates that do not allow the distribution of large volumes of data to a large number of computers.

One teledistribution solution often adopted is to place relay machines in each establishment using workstations or computers. However, that solution is difficult to make viable if the establishment does not have IT personnel on site, and it makes the deployment of teledistribution solutions very costly.

Some distribution systems operate in the opposite manner, i.e. the computers or workstations request to receive the data package. That leads to a further problem to be solved, involving the multiplicity of simultaneous requests.

Similarly, in the Internet environment, distribution requires over-specified IT platforms to handle the load necessary for transferring large volumes and where applicable to manage an influx of simultaneous requests.

### OBJECT AND SUMMARY OF THE INVENTION

An object of the invention is to eliminate those drawbacks and to simplify the distribution of large volumes of data or programs without saturating the information network.

The above objects are achieved by a method of distributing a data package by a control server to a plurality of computers distributed over a set of separate local networks, the method being characterized in that, at the request of a particular computer of a particular local network wishing to download the data package, the control server communicates to said particular computer either the name of a computer belonging to the particular local network that has previously downloaded said data package, called a depository computer for said data package, or the address of a central storage location holding said data package if the particular local network does not include another computer that has previously downloaded said data package.

The above method therefore enables distribution of large volumes of data to all the computers of each local network without installing additional repeaters. Moreover, this method transports the data package from the central storage location to a given local network only once.

According to a first aspect of the invention, the depository computer for said data package in the particular local network is a computer of the particular local network that has previously downloaded said data package and that has agreed at a given time to act as a server for distributing said data package.

Thus the data package is always stored as close as possible to the network of the requesting computer, enabling fast and secure transfer of data.

According to a second aspect of the invention, the control server includes a database containing the name of each of the computers, parameters for regulating the distribution of the data package, the address of the central storage location, and the names of the depository computers for said data package in the various local networks.

Thus the control server can know the distribution of the data packages at all times, enabling it to optimize distribution.

According to a third aspect of the invention, the request to receive a data package is sent periodically from the particular computer to the control server.

This limits the occupancy of a link between the control server and the particular computer.

The period of said request may be a parameter that can be set by the particular computer or by the control server.

There is therefore no restriction to a fixed period. Moreover, if the period is a parameter set by the control server, the streams of data can be regulated optimally to prevent congestion of the information networks.

The control server advantageously communicates the address of the storage location to said particular computer after consulting its database to verify if there is a package for said particular computer.

This eliminates errors concerning the recipient of the data package.

According to a further aspect of the invention, the control server stores in its database the name of said particular computer as the depository computer for the data package on the particular local network after it has received an indication that downloading has finished from said particular computer.

This guarantees that downloading has proceeded correctly before considering the particular computer to be the depository computer.

The control server advantageously prompts said particular computer to free the memory space containing the data package if said data package has been transferred to all the computers of the particular local network.

This economizes on the memory space of the particular computer.

The invention also consists in a system for distributing a data package, the system including a control server and a plurality of computers distributed over a set of separate local networks, and said control server including communication means for communicating to a particular computer on a particular local network wishing to download the data package, in response to a request from said particular computer, either the name of a computer belonging to the particular local network referred to as a depository computer for said data package that has previously downloaded said data package or the address of a central storage location holding said data package if the particular local network does not include another computer that has previously downloaded said data package.

The invention also consists in communication means enabling a control server, in response to a request from a particular computer on a particular local network wishing to download a data package, to communicate to said particular computer either the name of a computer belonging to the particular local network referred to as a depository computer for said data package that has previously downloaded said data package or the address of a central storage location holding said data package if the particular local network does not include another computer that has previously downloaded said data package.

The invention also consists in a computer program implemented in a control server including code instructions necessary for executing the method of distributing a data package having the features mentioned above.

### BRIEF DESCRIPTION OF THE DRAWINGS

Other features and advantages of the invention emerge from a reading of the following description given by way of illustrative and non-limiting example with reference to the appended drawings, in which:

FIG. 1 shows a system in accordance with the invention for distributing a data package, including a control server connected via an information network to a plurality of computers distributed over a set of separate local information networks;

FIG. 2 shows an example of a method of distributing a data package in the system from FIG. 1; and

FIG. 3 shows a prior art system for distributing a data package, including a central distribution server connected to a plurality of relay servers.

### DETAILED DESCRIPTION OF EMBODIMENTS

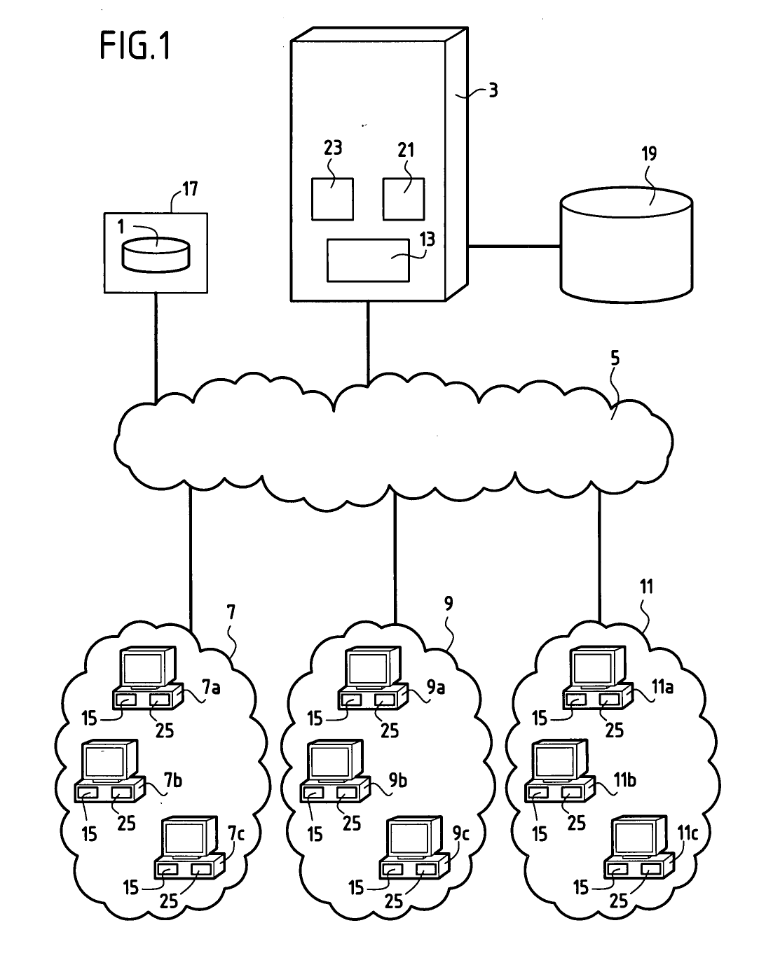

FIG. 1 shows a system according to the invention for distributing a data package 1, for example a software package, that system including a control server 3 connected via an information network 5 to a plurality of workstations or computers 7a to 7c, 9a to 9c, and 11a to 11c distributed over a set of separate local information networks 7, 9, and 11, respectively.

The control server 3 includes communication means 13 and each of the computers 7a to 11c includes respective communication means 15.

The communication means 13 of the control server 3 enable the control server 3, in response to a request from a particular computer 7a or 7b or 7c on a particular local network 7 or 9 or 11 wishing to download the data package 1, to communicate to that particular computer 7a or 7b or 7c the name of a computer belonging to the particular local network 7 or 9 or 11 that has previously downloaded the data package 1, called the depository computer for that data package. In contrast, if the particular local network 7 or 9 or 11 does not include another computer that has previously downloaded the data package 1, then the control server 3 communicates to the particular computer 7a or 7b or 7c the address of a central storage location 17 holding the data package 1.

The control server 3 includes a database 19 containing the name of each of the computers 7a to 11c to which the data package 1 can be distributed, parameters for regulating the distribution of the data package 1 (for example distribution calendar parameters), the address of the central storage location 17, and the names of the depository computers for the data package 1 in the various local networks 7, 9, and 11.

The control server 3 further includes a programming tool 21 which is used in conjunction with the database 19 to control and manage distribution of the data package 1. Setting parameters of the programming tool 21 so that it is able to distribute a plurality of identical or different packages of data in parallel over the same portion of a local information network 7, 9 or 11 may also be envisaged.

The distribution system further includes a data transfer program or software product 23 installed on the control server 3 and a corresponding software agent 25 installed on each computer 7a to 11c to enable correct distribution of the data package 1 by a method of the invention.

Note that the control server 3 can execute a program including coding instructions necessary for executing a method according to the invention for distributing a data package.

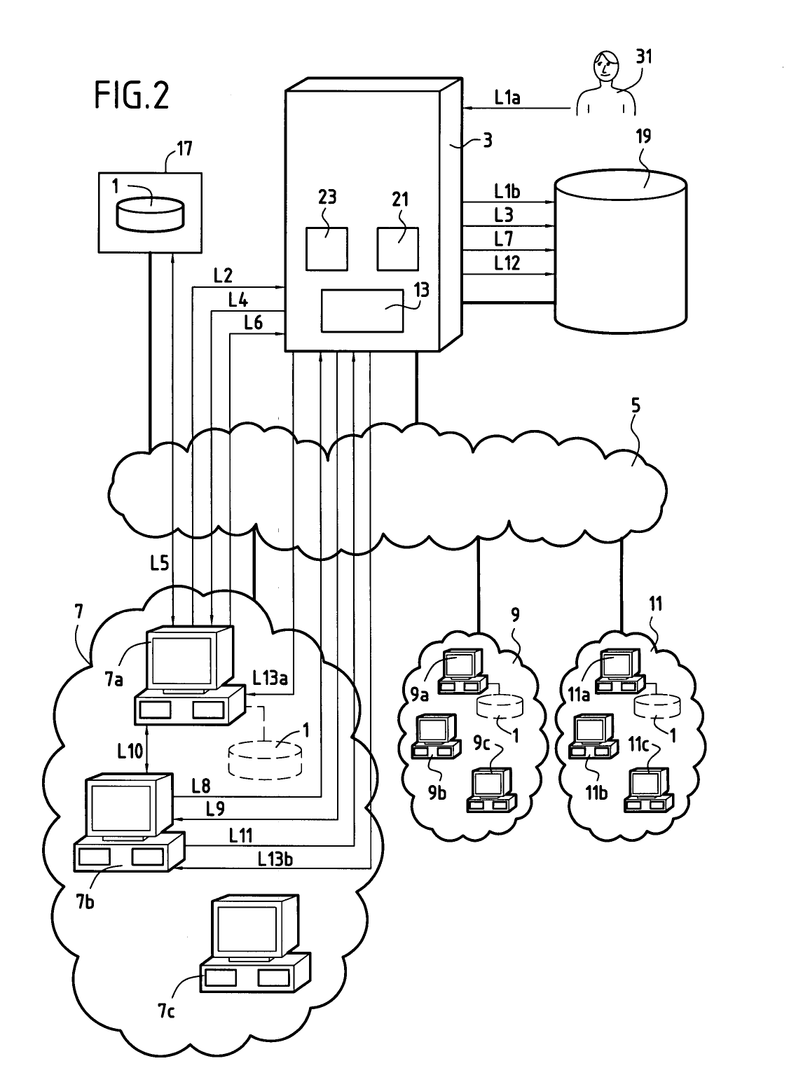

FIG. 2 shows one example of a method of distribution of a data package by the control server 3 to the plurality of computers 7a to 7c, 9a to 9c, and 11a to 11c distributed over the separate local networks 7, 9, and 11.

A service 31 responsible for distribution operates on the control server 3 via a link L1a to store in the database 19 (via a link L1b) the name(s) of the data package(s) to be distributed, a list of or the names of the computers 7a to 11c concerned, the date from which distribution may begin, the initial storage location(s) 17 of the data package(s) 1, and where appropriate other parameters such as the number of parallel distributions by the control server 3 that may be envisaged and the number of parallel distributions in each local network 7, 9 or 11 hosting the computers 7a to 11c that may be envisaged.

At a defined period, each workstation or computer 7a to 11c contacts the control server 3 and asks if it has a package to send it. It communicates its computer name for this purpose.

In the FIG. 2 example, a particular computer 7a of a particular local network 7 periodically sends the control server 3 (over a link L2) a request to receive the data package 1.

The request period may be parameter set by the particular computer 7a, i.e. generally by any computer of the set of computers 7a to 11c, or by the control server 3. This avoids congestion of the data networks and enables each computer optionally to select its own period.

Via a link L3, the control server 3 consults its database 19 to see whether the name of the particular computer 7a is in the list of computers concerned by the distribution and whether the calendar parameters allow distribution of the data package 1.

If the control server 3 detects a distribution for the particular computer 7a, it looks up the storage location(s) of the data package 1 to be distributed.

Then, via a link L4, the control server 3 communicates that storage location of the data package 1 to the particular computer 7a.

Generally speaking, if the particular local network 7 does not include another computer that has previously downloaded the data package 1, the storage location is the central storage location 17. However, if the particular local network 7 does include another computer that has previously downloaded the data package 1, then the storage location may be that other computer, referred to as the depository computer for the data package 1.

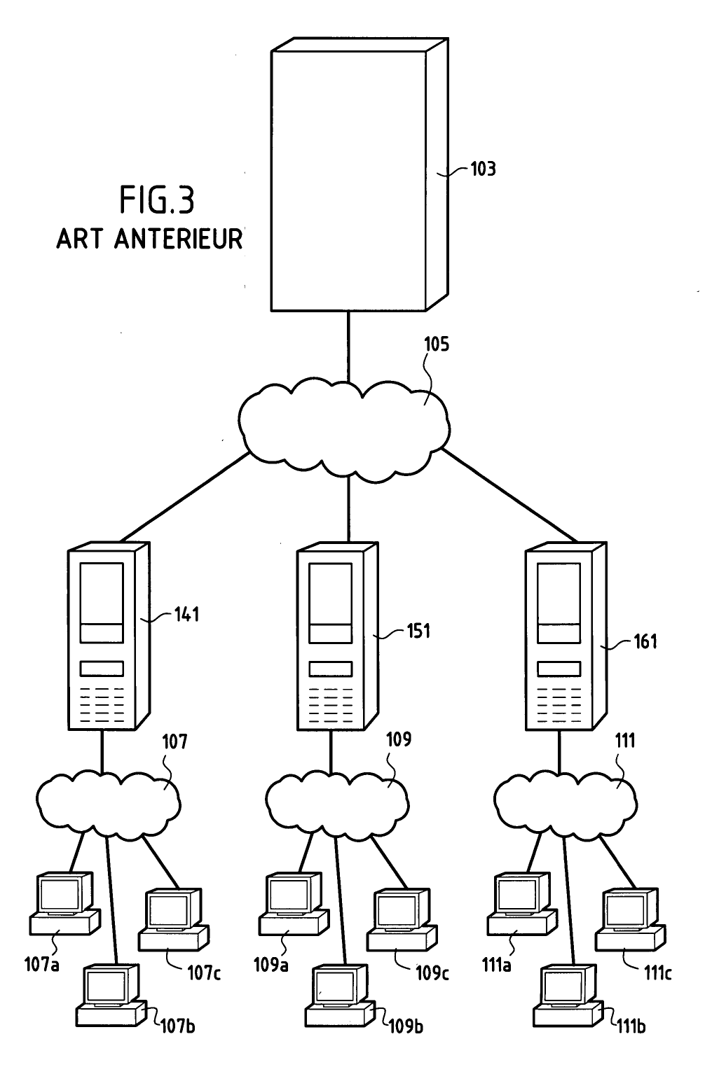

In the FIG. 3 example, since the particular local network 7 does not include another computer that has previously downloaded the data package 1, the control server 3 initially communicates to the particular computer 7a the address of the central storage location 17.

The particular computer 7a then downloads the data package 1 from the central storage location 17 via a link L5. The particular computer 7a may additionally perform post-download operations such as installing the data package 1.

Then, via a link L6, the particular computer 7a indicates to the control server 3 that the downloading has finished. After downloading has proceeded correctly, the control server 3 then stores (link L7) in its database 19 the name of the particular computer 7a as a depository computer for the data package 1 on the particular local network 7a.

Thus the depository computer for the data package 1 in the particular local network 7a generally corresponds to a computer of the particular local network 7 that has previously downloaded the data package 1 and that agrees at a given time to act as a server for distributing that data package 1.

Via a link L8, another particular computer 7b of the particular network 7 in turn interrogates the control server 3.

The control server 3 performs the same searches as before, but communicates (link L9) to this other particular computer 7b, as the storage location, the name of the particular computer 7a that has previously requested the data package 1 and that has agreed to store it temporarily and to redistribute it.

Via a link L10, this other particular computer 7b then sends a transfer request to the particular computer 7a, whose name it knows. Following the transfer of the data package 1, it advises (link L11) the control server 3 that it is now a depository for the data package 1 on its local network.

The control server 3 then stores (link L12) the new storage location 7b for the data package 1 on this local network.

The above operations are carried out for as long as there remain recipients 7c of a local network 7 that have not received the data package 1.

To economize on memory space, the control server 3 advantageously prompts the particular computer 7a or 7b that is the depository computer for the data package 1 via a link L13a or L13b to free the memory space containing that data package if the package has been transferred to all the computers 7a, 7b, and 7c of the particular local network 7.

Of course, the actions described above are valid for each of the local networks 7, 9, and 11 and may be implemented for business use or for e-commerce use.

Thus the method according to the invention relies on a “workflow” type system enabling each computer 7a to 11c to request distribution, knowing that the data package 1 is always stored as close as possible to the network of the requesting computer.

The control server 3 having a maximum simultaneous transfer capacity, it is possible to add a further general parameter of the control server 3 indicating the total number of distributions that is possible. In the event of reaching that value, the control server 3 informs the requesting computers 7a to 11c accordingly and they connect to the control server 3 after a delay fixed in advance by setting parameters, or after a random delay.

It is possible to envisage storing information in the database 19 concerning a plurality of simultaneous distributions over each segment of a local network 7, 9, and 11. The bit rate of an information network, its average load in an identical period, and the size of the package to be distributed would be sufficient to calculate the number of distributions that is possible at a given time.

If the control server 3 has a low simultaneous transfer capacity, it is possible to manage a plurality of centralized storage locations for the data packages 1.

To ensure distribution to all the computers 7a to 11c, it is possible to supply to an IT correspondent a list of the computers that have not contacted the control server 3 in the authorized time period, in order for the correspondent to launch the process manually or to declare those computers as temporarily or permanently out of service.

Using a standard distribution tool which, given the small number of computers that have not contacted the control server 3, carries out this task without causing congestion on the information networks may also be envisaged.

Note that in the Internet environment, subject to the provision of a discount or “bonus points” system for customers agreeing to act as redistributors, the e-merchant service platform may be relieved of the transfer as such of the data to be sent, whilst guaranteeing controlled delivery. This has the advantage of reducing the size of the platform.

1. A method of distributing a data package (1) by a control server (3) to a plurality of computers (7a to 11c) distributed over a set of separate local networks (7, 9, 11), wherein, at the request of a particular computer (7a) of a particular local network (7) wishing to download the data package (1), the control server (3) communicates to said particular computer (7a) either the name of a computer belonging to the particular local network (7) that has previously downloaded said data package (1), called a depository computer for said data package, or the address of a central storage location (17) holding said data package (1) if the particular local network (7) does not include another computer that has previously downloaded said data package (1).

2. The method according to claim 1, wherein the depository computer for said data package (1) in the particular local network (7) is a computer of the particular local network (7) that has previously downloaded said data package (1) and that has agreed at a given time to act as a server for distributing said data package (1).

3. The method according to claim 1, wherein the control server (3) includes a database containing the name of each of the computers (7a to 11c), parameters for regulating the distribution of the data package (1), the address of the central storage location (17), and the names of the depository computers for said data package in the various local networks (7, 9, 11).

4. The method according to claim 1, wherein the request to receive a data package (1) is sent periodically from the particular computer (7a) to the control server (3).

5. The method according to claim 4, wherein the period of said request is a parameter that can be set by the particular computer (7a) or by the control server (3).

6. The method according to claim 1, wherein the control server (3) communicates the address of the storage location to said particular computer (7a) after consulting its database (19) to verify if there is a package for said particular computer.

7. The method according to claim 1, wherein the control server (3) stores in its database (19) the name of said particular computer as the depository computer for the data package (1) on the particular local network (7) after it has received an indication that downloading has finished from said particular computer (7).

8. The method according to claim 1, wherein the control server (3) prompts said particular computer (7a) to free the memory space containing the data package (1) if said data package has been transferred to all the computers of the particular local network.

9. A system for distributing a data package, the system including a control server (3) and a plurality of computers (7a to 11c) distributed over a set of separate local networks (7, 9, 11), wherein said control server includes communication means (13) for communicating to a particular computer on a particular local network (7, 9, 11) wishing to download the data package (1), in response to a request from said particular computer (7a to 11c), either the name of a computer belonging to the particular local network referred to as a depository computer for said data package that has previously downloaded said data package or the address of a central storage location (17) holding said data package if the particular local network does not include another computer that has previously downloaded said data package.

10. The system according to claim 9, wherein the control server includes a database containing the name of each of the computers (7a to 11c), parameters for regulating the distribution of the data package (1), the address of the central storage location (17), and the names of the depository computers for said data package (1) in the various local networks (7, 9, 11).

11. Communication means enabling a control server, in response to a request from a particular computer (7a to 11c) on a particular local network (7, 9, 11) wishing to download a data package (1), to communicate to said particular computer either the name of a computer belonging to the particular local network referred to as a depository computer for said data package that has previously downloaded said data package or the address of a central storage location (17) holding said data package if the particular local network does not include another computer that has previously downloaded said data package.

12. A computer program implemented in a control server, including code instructions necessary for executing the method according to claim 1, for distributing a data package.
